(19) United States
(12) Patent Application Publication
(10) Pub. No.: US 2009/0130514 A1
(43) Pub. Date: May 21, 2009

(54) Membrane electrode assembly for fuel cell, method of producing same, and fuel cell

(75) Inventors: Hiroshi Okura, Kanagawa-ken (JP); Masaaki Shibata, Tokyo (JP); Yoshinobu Okumura, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/658,409

(22) PCT Filed: Oct. 13, 2005
(86) PCT No.: PCT/JP05/19263

§ 371 Date: Jan. 25, 2007

(30) Foreign Application Priority Data
Oct. 14, 2004 (JP) 2004-300685

(51) Int. Cl. H01M 8/10; B05D 5/12

(52) U.S. Cl. 429/30; 427/115

(57) ABSTRACT

Provided is a membrane electrode assembly for a fuel cell which comprises a polymer electrolyte 13 and a catalyst layer 16, wherein the catalyst layer 16 comprises a wire-shaped catalyst 12. Also provided is a method of producing a membrane electrode assembly for a fuel cell comprising a polymer electrolyte and a catalyst layer comprising a wire-shaped catalyst, which comprises the step of producing a wire-shaped catalyst by means of vapor phase growth or liquid phase growth. With such a constitution, the gas permeability can be increased and the power generation efficiency can be improved.

### TECHNICAL FIELD

The present invention relates to a membrane electrode assembly for a fuel cell, a method of producing the same, and a fuel cell using the membrane electrode assembly.

### BACKGROUND ART

A fuel cell is a device that uses oxygen or the air for a cathode and hydrogen, methanol, a hydrocarbon or the like for an anode to produce an electrical energy, and is clean and provides high power generation efficiency. The fuel cell can be classified into an aqueous alkaline solution type fuel cell, an aqueous phosphoric acid solution type fuel cell, a molten carbonate type fuel cell, and the like depending on the kind of an electrolyte used. In recent years, a proton-exchange membrane fuel cell has been attracting attention. The proton-exchange membrane fuel cell has the following advantages. That is, the cell can be easily handled because it is operated at a low temperature. The cell has a simple cell structure, so that the maintenance of the cell can be easily attained. A membrane of the cell can withstand a differential pressure, so that pressurization control of the cell can be easily attained. The cell can be reduced in size and weight because it provides a high output density.

Such proton-exchange membrane fuel cell generally uses a fluororesin-based ion-exchange membrane as a solid electrolyte for a proton conductor. In addition, the cell uses platinum fine particles each having a low activation overvoltage as a catalyst for promoting a hydrogen oxidation reaction and an oxygen reduction reaction. An electrode reaction occurs at a so-called triple phase boundary (between electrolyte/catalyst-electrode/fuel). In the proton-exchange membrane fuel cell, because a solid membrane is used as an electrolyte, a reaction occurs only at a contact interface between a catalyst electrode and an electrolyte membrane, so that the utilization ratio of platinum tends to lower. Japanese Patent Application Laid-Open No. H06-176765 can be mentioned as introducing an example of technique to alleviate such tendency.

However, because a conventional proton-exchange membrane fuel cell has used small and nearly spherical fine particles each having a diameter of several nanometers to several ten nanometers as a catalyst in order to increase the surface area, a gap between fine particles or between catalyst-carrying carbons is very narrow. Thus, the utilization ratio of the catalyst has been very low by reason of, for example, the inability of an electrolyte to penetrate between catalyst electrodes and the inability of a reaction gas to permeate into the catalyst electrode. Therefore, there has been a great need for development of a novel membrane electrode assembly for a fuel cell that maintains the advantages of the conventional proton-exchange membrane fuel cell.

The present invention has been made in view of such background art as described above, and it is, therefore, an object of the present invention to provide a membrane electrode assembly for a fuel cell that can increase the triple phase boundary, also can improve the gas permeability and is improved in the power generation efficiency, a method of producing the same, and a fuel cell.

### DISCLOSURE OF THE INVENTION

According to one aspect of the present invention, there is provided a membrane electrode assembly for a fuel cell comprising a polymer electrolyte and a catalyst layer, wherein the catalyst layer comprises a wire-shaped catalyst.

In the present invention, it is preferred that the wire-shaped catalyst has an aspect ratio of 5 or more.

Further, it is preferred that the wire-shaped catalyst has a diameter of 50 nm or less.

Moreover, it is preferred that the wire-shaped catalyst comprises platinum, an alloy containing platinum, or a mixture containing platinum.

According to another aspect of the present invention, there is provided a method of producing a membrane electrode assembly for a fuel cell comprising a polymer electrolyte and a catalyst layer comprising a wire-shaped catalyst, the method comprising the step of making a wire-shaped catalyst by means of vapor phase growth or liquid phase growth.

In the present invention, it is preferred that the vapor phase growth is condensation, thermal decomposition, laser ablation, or VLS.

Further, it is preferred that the liquid phase growth is plating, electroless plating, or reduction.

According to still another aspect of the present invention, there is provided a method of producing a membrane electrode assembly for a fuel cell comprising a polymer electrolyte and a catalyst layer comprising a wire-shaped catalyst, the method comprising the steps of preparing a template having a hole substantially linearly penetrated therethrough on an electrode; filling the hole with a substance that serves as a catalyst by means of plating; dissolving the template with an acid or alkaline solution to give a catalyst layer comprising a wire-shaped catalyst; and integrating the catalyst layer with a polymer electrolyte.

In the present invention, it is preferred that the template is an alumina nanohole, a silicon nanohole, or a silica nanohole.

According to yet another aspect of the present invention, there is provided a fuel cell using the above-mentioned membrane electrode assembly.

According to the present invention, there can be provided a membrane electrode assembly for a fuel cell which can increase the triple phase boundary, also can improve the gas permeability, and is improved in the power generation efficiency, a method of producing the same; and a fuel cell using the membrane electrode assembly.

Furthermore, the fuel cell of the present invention has the following advantages. For example, the cell can be easily handled because it is operated at a low temperature. The cell has a simple cell structure, so that the maintenance of the cell can be easily attained. The membrane of the cell can withstand a differential pressure, so that pressurization control of the cell can be easily attained. The cell can be reduced in size and weight because it provides a high output density.

### BRIEF DESCRIPTION OF THE DRAWINGS

FIGS. 1A, 1B, and 1C are schematic views each showing the construction of a membrane electrode assembly in accordance with the present invention;

FIGS. 2A, 2B, 2C, 2D, and 2E are schematic views each showing the shape of a wire-shaped catalyst of a membrane electrode assembly in accordance with the present invention;

FIGS. 3A, 3B, and 3C are schematic views each explaining the definition of the wire-shaped catalyst of the membrane electrode assembly in accordance with the present invention;

FIG. 4 is a schematic view of a membrane electrode assembly; and

FIG. 5 is a schematic view of a fuel cell.

### BEST MODE FOR CARRYING OUT THE INVENTION

Hereinafter, the present invention will be described in more detail.

The membrane electrode assembly for a fuel cell in accordance with the present invention comprises a polymer electrolyte and a catalyst layer, wherein the catalyst layer comprises a wire-shaped catalyst.

Here, the definition and construction of the wire-shaped catalyst, examples of methods of producing the wire-shaped catalyst in a liquid and vapor phase, the polymer electrolyte membrane, a carrier, the construction and production method of the membrane electrode assembly, and the construction and production method of a fuel cell will be described in detail.

### <Wire-Shaped Catalyst>

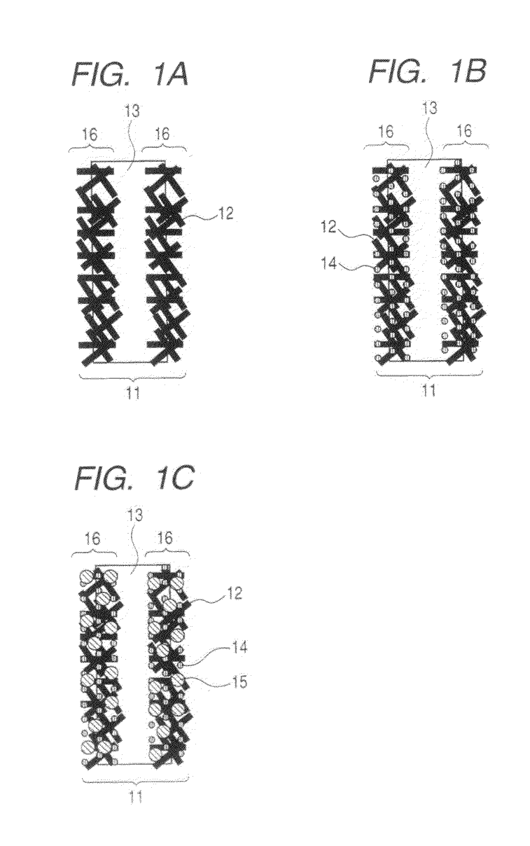

The wire-shaped catalyst in the catalyst layer of the proton-exchange membrane fuel cell in the present invention is a wire-shaped catalyst 12 existing in a membrane electrode assembly 11 as shown in FIG. 1A. Reference numeral 16 denotes a catalyst layer, and the catalyst layer 16 comprises the wire-shaped catalyst 12.

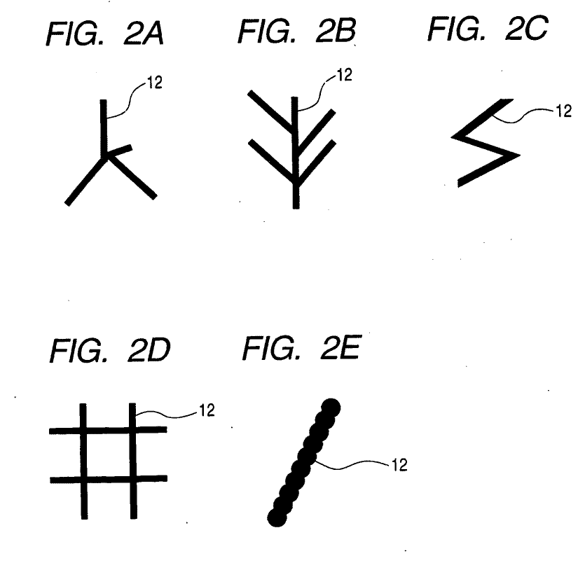

The term “wire-shaped catalyst” herein employed refers to a one-dimensional structural member comprising a catalytic substance and having a thin wire shape and a longitudinal length larger than the maximum length of a line segment that passes through a center of gravity of the structural member in a widthwise cross section including the center of gravity of the structural member and is limited by the periphery of the cross section. Furthermore, as shown in FIGS. 2A, 2B, 2C, 2D, and 2E, examples of the wire-shaped catalyst include: one in which two or more wire-shaped members are grown from a single point, including one of a tetrapod shape (FIG. 2A); one formed into a dendritic shape (FIG. 2B); one grown into a polyline shape (FIG. 2C); one grown into a mesh shape (FIG. 2D); and one grown into a string of beads shape (FIG. 2E). Further, the wire-shaped catalyst itself may have a hollow shape (tubular shape) or a plate shape.

The catalyst layer in the membrane electrode assembly may be formed only of a wire-shaped catalyst 12, or may be formed of a mixture of a wire-shaped catalyst 12 and fine particles 14 as shown in FIGS. 1A and 1B. Of course, as shown in FIG. 1C, the catalyst layer may contain a carrier 15.

Examples of the shape of the wire-shaped catalyst include a columnar shape and a cone shape, including a cone shape with its tip being flat or enlarged and a columnar shape with its tip being sharp, flat or enlarged. Such examples also include a polygonal cone shape such as a triangular cone shape, a square cone shape, a hexagonal cone shape, and the like, including a polygonal cone shape with its tip being flat or enlarged; a polygonal columnar shape such as a triangle columnar shape, a square columnar shape, a hexagonal columnar shape, and the like, including a polygonal columnar shape such as a triangle columnar shape, a square columnar shape, or a hexagonal columnar shape with its tip being sharp or enlarged; and other polygonal columnar shapes with their tips being flat or enlarged. Moreover, polyline-shaped structures of the above-mentioned shapes are also included.

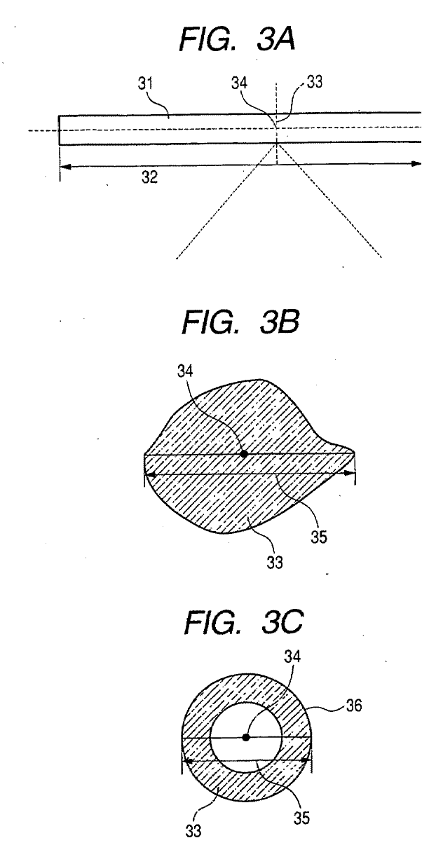

The wire-shaped catalyst used for the membrane electrode assembly in accordance with the present invention has an aspect ratio of preferably 5 or more, and more preferably 10 or more. Further, the above-mentioned maximum length of a line segment that passes through a center of gravity of the wire-shaped catalyst in a widthwise cross section including the center of gravity of the wire-shaped catalyst and is limited by the periphery of the cross section is preferably 50 nm or less, and more preferably 20 nm or less. As shown in FIG. 3A, the term “aspect ratio” herein employed refers to the ratio of a length 32 to a diameter of a wire-shaped catalyst 31 when a widthwise cross section 33 including a center of gravity 34 of the wire-shaped catalyst 31 is of a circular shape or a nearly circular shape. Further, when a widthwise cross section 33 including a center of gravity 34 of a wire-shaped catalyst 31 is of, for example, a hexagonal shape or a distorted shape as shown in FIGS. 3A and 3B, the term is intended to mean the ratio of the length 32 to a maximum length 35 of a line segment that passes through the center of gravity 34 of the wire-shaped catalyst 31 in a widthwise cross section 33 including the center of gravity 35 and is limited by the periphery of the cross section 33. Moreover, when a widthwise cross section 33 including a center of gravity 34 of a wire-shaped catalyst 31 is of a ring shape as shown in FIG. 3C, the wire-shaped catalyst 31 is assumed to be a structural member formed of an outermost ring 36 of the widthwise cross section 33, and the term is intended to refer to the ratio of the length 32 to the maximum length 35 of a line segment passing through the center of gravity 34.

Here, the wire-shaped catalyst is not limited as long as it can serve as a catalyst electrode of a fuel cell, and, in particular, platinum, an alloy containing platinum, or a mixture containing platinum is preferably used for the catalytic substance. Examples of a material to be used in combination with platinum to prepare an alloy of platinum or a mixture containing platinum include gold, silver, palladium, iridium, rhodium, ruthenium, iron, cobalt, nickel, chromium, tungsten, manganese, vanadium, rhenium, cobalt, lithium, lanthanum, strontium, yttrium, and osmium. A catalyst to be used for a catalyst electrode is not limited to those materials as long as it is a material capable of promoting the oxidation reaction of an anode side fuel such as hydrogen and the reduction reaction of a cathode side fuel such as oxygen.

### <Method of Producing Wire-Shaped Catalyst>

The method of producing a wire-shaped catalyst will be described with reference to FIGS. 1A to 1C.

Examples of the method of producing a wire-shaped catalyst include: a liquid phase growth method involving voltage application or reduction in the presence of metal ions as a source material for a wire-shaped catalyst in a solution to thereby grow the wire-shaped catalyst; and a vapor phase growth method involving applying an external energy to a source material for a wire-shaped catalyst to make the wire-shaped catalyst in a vapor phase. However, the method is not limited to them.

Here, as the vapor phase growth method, a condensation method is suitably used which involves evaporating or sublimating a metal source material; and effecting aggregation at a site having a temperature lower than the temperature at which the evaporation or sublimation is performed to thereby make a wire-shaped catalyst. Alternatively, a thermal decomposition method is suitably used which involves thermally decomposing a metal halide in a vacuum or in an inert gas to make a wire-shaped catalyst. Alternatively, a VLS method is suitably used which involves preparing a catalyst capable of serving as a growth starting point and reacting a desired metal vapor with the catalyst to grow a wire-shaped catalyst.

Further, as the liquid phase growth method, a plating method is also suitably used which involves causing desired metal ions to grow through electrolysis by means of a template capable of forming a wire-shaped catalyst therein. Moreover, an electroless plating method is suitably used which involves causing a wire-shaped catalyst to grow by means of a catalyst or a light source. In addition, a reduction method is suitably used which involves mixing a reducing agent, a surfactant for forming a wire-shaped catalyst, and the like in a solution to cause the wire-shaped catalyst to grow.

Here, for example, a method of making a wire-shaped catalyst in a solution by means of a cylinder-shaped template will be described in detail.

First, a template for making a wire-shaped catalyst is prepared. An alumina nanohole produced by anodic oxidation of aluminium is taken here as an example of a template for a wire-shaped catalyst. Incidentally, the template is not limited to an alumina nanohole, and any template may be used as long as it is capable of forming a wire-shaped catalyst, and examples of such template include: a silicon nanohole produced by simultaneous sputtering of aluminium and silicon; a silica nanohole produced by means of a source material of silica, a surfactant, and the like; and a polymer such as of polymethylmethacrylate or the like formed by self-organization of molecules.

First, an aluminium electrode to serve as a working electrode and an aluminum electrode to serve as a counter electrode are set in a 0.3M aqueous solution of sulfuric acid held at 3° C. by a constant temperature water tank. Here, an anodic oxidation voltage used is DC 25 V; a current value is displayed on a monitor; and penetration up to a base layer is confirmed at the time when the current value lowers.

After the anodic oxidation, washing with pure water and isopropyl alcohol is performed. Then, a pore widening treatment involving immersion in a 5 wt % aqueous phosphoric acid solution is performed for 20 minutes to form alumina nanoholes having an average pore diameter of 20 nm. Any one of the methods described in, for example, Japanese Patent Application Laid-Open Nos. 2000-31462 and 2003-266400 can be used as the method of producing an alumina nanohole.

Next, an electrolytic solution containing at least platinum ions is prepared. By immersing the alumina nanohole substrate into the solution and applying a potential, a platinum wire-shaped catalyst can be produced. Examples of a compound that can be used as a salt containing platinum include hexachloro platinum (IV) acid, dinitrodiammineplatinum (II), tetraamminedichloroplatinum (II), and potassium hexahydroxoplatinate (IV). Further, when a platinum alloy is to be produced by means of electrodeposition, the alloy can be produced by mixing a salt containing a desired metal in an electrolytic solution containing the above-mentioned platinum ions.

### <Polymer Electrolyte>

The polymer electrolyte constituting the membrane electrode assembly in accordance with the present invention is required to have a high ionic conductivity in order to quickly move cations generated on an anode to a cathode side. A material excellent in hydrogen ion conductivity and in permeability for an organic liquid fuel such as methanol is preferably used for the polymer electrolyte in order to satisfy such requirement.

More specifically, there is preferably used an organic polymer having an organic group capable of hydrogen ion dissociation, such as sulfonic group, sulfinic group, carboxyl group, a phosphonic group, phosphinic group, phosphate group, and hydroxyl group. Examples of such organic polymer include perfluorocarbon sulfonate resin, polystyrene sulfonate resin, sulfonated polyamide-imide resin, sulfonated polysulfonate resin, sulfonated polyether-imide semi-permeable membrane, perfluoro phosphonic acid resin, and perfluoro sulfonic acid resin. Those polymer electrolytes exemplified above are suitably used, but the polymer electrolyte is not limited to them.

### <Fine Particles>

As shown in FIGS. 1B and 1C, the membrane electrode assembly may contain fine particles as a catalyst. The fine particle may be made of any material and may be of any shape as long as it is a substance capable of functioning as a catalyst for a fuel cell or as a co-catalyst improving the catalytic ability. In particular, when an increase in reaction field of the wire-shaped catalyst in accordance with the present invention is taken into consideration, fine particles having a diameter smaller than the diameter of the wire-shaped catalyst are suitably used. More specifically, fine particles having a diameter of preferably 20 nm or less, more preferably 10 nm or less can be used. In addition, platinum, an alloy containing platinum, or a mixture containing platinum is preferably used as a material for the catalyst. Examples of a material to be used in combination with platinum to prepare an alloy of platinum or a mixture containing platinum include gold, silver, palladium, iridium, rhodium, ruthenium, iron, cobalt, nickel, chromium, tungsten, manganese, vanadium, rhenium, cobalt, lithium, lanthanum, strontium, yttrium, and osmium.

### <Carrier>

Because a membrane electrode assembly can basically generate a power by virtue of the presence of a polymer electrolyte membrane capable of transporting cations to an anode side and catalyst electrodes capable of taking out electrons generated at an anode and a cathode, a carrier is not an indispensable material. However, a material capable of allowing electron movement is carried in a membrane electrode assembly mainly for reducing the amount of platinum to be used.

Carbon can be mainly used for the carrier, but a material that can be used therefor is not limited to carbon as long as it is an electron conductive material. Examples of a carrier made of carbon include: carbon black such as furnace black, channel black, and acetylene black; activated carbon; graphite; fullerene; a carbon nanotube; and a carbon fiber. Each of them may be used singly, or two or more of them may be used in combination. At this time, a wire-shaped catalyst may be formed on the carrier, or the carrier and a wire-shaped catalyst may be dispersed into a membrane electrode assembly.

### <Construction and Production Method of Membrane Electrode Assembly>

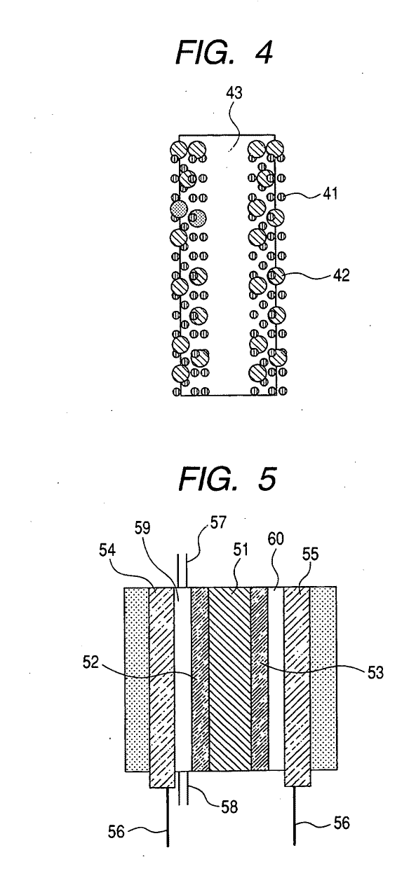

FIG. 4 shows the basic construction of a membrane electrode assembly, which is generally composed of a catalyst 41, a carrier 42, and a polymer electrolyte 43.

The following reactions proceed when the membrane electrode assembly is used and, for example, hydrogen and oxygen are used for an anode side and a cathode side, respectively.

Anode electrode H₂→2H⁺+2e⁻

Cathode electrode ½O₂+2H⁺+2e⁻→H₂O

As can be seen from the above reaction formulae, a system is established, in which supplied fuel generates electrons and cations on an anode side, and only the generated cations move to a cathode side and then react with oxygen to consume the electrons, thereby generating power. In other words, it is important that the cathode and the anode be completely separated by a polymer electrolyte while being installed in the same membrane electrode assembly. Furthermore, the above reactions are carried out at an interface among three kinds of substances of a catalyst electrode, the polymer electrolyte, and fuel, so that it is important that: the polymer electrolyte be disposed over a wide range on the catalyst electrode; and the fuel be supplied deeply into the membrane electrode assembly efficiently. Therefore, a mixing ratio between a material for the catalyst electrode and the polymer electrolyte can also be an important parameter in improvement of performance of a fuel cell.

Methods of producing the membrane electrode assembly can be roughly classified into two methods. One method involves placing a substance obtained by mixing in advance a material for the catalyst electrode and the polymer electrolyte on a polymer electrolyte membrane. The other method involves placing a catalyst electrode on a polymer electrolyte membrane, and then placing a polymer electrolyte thereon. Here, details about the former method will be described in detail.

1 g of a produced platinum nanowire-shaped catalyst is put into a crucible, and 0.4 cc of pure water is added dropwise by means of a micropipet. A carrier, if used, is mixed at this time. After that, 1.5 cc of a 5% Nafion solution is added into the crucible by means of a micropipet, and then 0.2 cc of isopropyl alcohol is added. Then, the crucible is subjected to ultrasonic cleaning for 5 minutes. Furthermore, a stirrer is placed into the crucible, and the content in the crucible is stirred by means of a magnetic stirrer at 200 rpm. A platinum nanowire-shaped catalyst dispersion liquid thus prepared is applied to a PTFE sheet by means of a doctor blade method. The catalyst sheet produced is moved to another place and dried in the air.

Next, a step of preparing a polymer electrolyte membrane will be described. In the step, commercially available Nafion (trade name) membrane was used. An aqueous solution of hydrogen peroxide was heated to 80° C., and a Nafion membrane cut into a desired size was immersed in the solution for 60 minutes. After having been treated with hydrogen peroxide, the Nafion membrane was washed with water, and was then immersed for 60 minutes in an aqueous sulfuric acid solution as heated to 80° C. After that, the membrane was washed with water and dried before use.

Next, the catalyst sheet applied to the PTFE sheet previously produced was pressed by means of hot pressing against the Nafion membrane after the treatment, to thereby manufacture a membrane electrode assembly of a Nafion containing platinum nanowire-shaped catalyst.

### <Fuel to be Supplied>

A fuel used on an anode side for a fuel cell of a polymer electrolyte-catalyst composite type is not limited as long as the fuel generates electrons and cations by virtue of actions of a catalyst electrode and a polymer electrolyte, and examples of such fuel include hydrogen, reformed hydrogen, methanol, and dimethyl ether. A fuel used on a cathode side for the fuel cell is not limited as long as the fuel receives cations and takes electrons therein, and examples of such fuel include air and oxygen. Incidentally, it is preferable in terms of reaction efficiency and usefulness to employ hydrogen or methanol on the anode side and air on the cathode side.

### <Construction and Production Method of Fuel Cell>

FIG. 5 is a schematic view showing the construction of the above fuel cell. The fuel cell is composed of a polymer electrolyte 51, an anode catalyst layer 52, a cathode catalyst layer 53, an anode side current collector 54, a cathode side current collector 55, an external output terminal 56, a fuel supply line 57, a fuel discharge line 58, an anode side fuel diffusion layer 59, and a cathode side fuel diffusion layer 60. A chemical reaction occurs at a triple phase boundary on the surface of a catalyst layer to generate power. Here, for example, by forming a plurality of layers each having the cell construction shown in FIG. 5, the values of generated voltage and current can be increased. In this case, if the above cells are produced by applying a semiconductor process, compactization of a fuel cell system and an increase in output of the system can be achieved.

For example, when hydrogen and air are used as fuels for an anode side and a cathode side, respectively, it is important to perform packing to prevent a fuel supplied to the anode side from leaking. It is important that the cathode side be open to the air to facilitate the injection of the fuel. The term “diffusion layer” herein employed refers to a conductive member having a high porosity, which is installed in order to facilitate the carrying of a fuel into a cell and to form an increased number of triple phase boundaries. A carbon fiber fabric, carbon paper, or the like can be suitably used for the diffusion layer.

Of course, the membrane electrode assembly for a fuel cell in accordance with the present invention is applicable to not only the case where a polymer electrolyte for performing cation exchange is used but also a case where a wire-shaped catalyst is used for a catalyst electrode of, for example, a bipolar electrolyte-type fuel cell using a cation-exchange membrane for an anode side and an anion-exchange membrane for a cathode side.

Hereinafter, the present invention will be described in more detail by way of examples. However, the present invention is not limited to these examples.

### EXAMPLE 1

In this example, a silicon nanohole film was used as a template and subjected to platinum plating to make a wire-shaped catalyst, and then a membrane electrode assembly was produced.

First, an aluminum-silicon mixed film of 200 nm in thickness was formed by means of an RF magnetron sputtering method on a Si wafer having a copper film formed thereon. The target used was prepared by placing, on an aluminum target of 4 inches (101.6 mm) on a backing plate, six 15 mm-square silicon chips. The sputtering was performed by means of an RF power source under the conditions of: an Ar flow rate of 50 sccm; a discharge pressure of 0.7 Pa; and an input power of 90 W. The substrate temperature was room temperature. The aluminum-silicon mixed film was immersed in a 5 wt. % aqueous solution of phosphoric acid for 10 hours, and only aluminum columnar structure portions were selectively etched to form fine pores. The film after the etching was observed with a field emission scanning electron microscope (FE-SEM). As a result, the film was observed to be a porous film having an average pore size of about 5 nm.

Next, columnar structural members of platinum were formed by mean of electrodeposition (electroplating) in the fine pores of the porous film thus produced. The porous thin film of silicon oxide produced in the above step was immersed in a commercially available electroplating solution (manufacture by KOJUNDO CHEMICAL LABORATORY CO., LTD.; an electroplating solution for gold; trade name: PT-100E), and was subjected to electrodeposition in an acid bath held at 70° C. (pH 0.1) at a current density of 1.5 A/dm².

Next, the substrate was taken out of the solution, and was then immersed in a 0.2M aqueous solution of sodium hydroxide for 30 minutes to dissolve the template, thereby producing a platinum wire-shaped catalyst grown on the substrate. The film after the etching was observed with an FE-SEM. As a result, the film was observed to be a columnar film reflecting the template and having an average diameter of about 5 nm. Furthermore, in order to separate the platinum wire-shaped catalyst from the substrate, the substrate was immersed in an aqueous solution of nitric acid to dissolve copper. Thus, a platinum wire-shaped catalyst having a length of 200 nm and a diameter of 5 nm was produced.

The platinum nanowire-shaped catalyst was used to produce a membrane electrode assembly in the same manner as the above-described method of producing a membrane electrode assembly, to thereby assemble a cell in which hydrogen and air were taken as fuels into an anode side and a cathode side, respectively. The method was as follows. 1 g of the produced platinum nanowire-shaped catalyst was put into a crucible, and 0.4 cc of pure water was added dropwise by means of a micropipet. After that, 1.5 cc of a 5% Nafion solution were added into the crucible by means of a micropipet, and then 0.2 cc of isopropyl alcohol was added. Then, the crucible was subjected to ultrasonic waves for 5 minutes. Furthermore, a stirrer was placed into the crucible, and the content in the crucible was stirred by means of a magnetic stirrer at 200 rpm. A platinum nanowire-shaped catalyst dispersion liquid thus prepared was applied to a PTFE sheet by means of a doctor blade method. The catalyst sheet produced was moved to another place and dried in the air.

Next, the step of pretreating a polymer electrolyte membrane will be described. In the step, a commercially available Nafion (trade name) membrane was used. An aqueous solution of hydrogen peroxide was heated to 80° C., and a Nafion membrane cut into a desired size was immersed in the solution for 60 minutes. After having been treated with hydrogen peroxide, the Nafion membrane was washed with water, and was then immersed for 60 minutes in an aqueous solution of sulfuric acid heated to 80° C. After that, the membrane was washed with water and dried before use.

Next, the catalyst sheet applied to the PTFE sheet previously produced was pressed by means of hot pressing against the Nafion membrane after the treatment, to thereby producing a membrane electrode assembly of a Nafion containing platinum nanowire-shaped catalyst.

FIG. 5 schematically shows a construction obtained by incorporating the membrane electrode assembly into a cell. The cell is composed of the polymer electrolyte 51, the anode catalyst layer 52, the cathode catalyst layer 53, the anode side current collector 54, the cathode side current collector 55, the external output terminal 56, the fuel supply line 57, the fuel discharge line 58, the anode side fuel diffusion layer 59, and the cathode side fuel diffusion layer 60.

As a comparative example, a membrane electrode assembly was produced in the same manner as that described above by means of fine particles having an average particle size of 5 nm, and the member was used to produce a cell.

The single fuel cell was evaluated for current-potential characteristics. As a result, Example 1 showed an improvement of output by about 10% as compared to the fine particle membrane of the comparative example. This is probably because the incorporation of the platinum wire-shaped catalyst in accordance with the present invention into the membrane electrode assembly has enabled the triple phase boundary to be increased and the gas permeability to be increased, thereby leading to the improvement of the power generation efficiency.

### <Method of Evaluating Current-Potential Characteristics>

Hydrogen humidified with water vapor at 80° C. was used for an anode side, and air similarly humidified was used for a cathode side. Hydrogen and air were supplied at flow rates of 200 mL/min and 600 mL/min, respectively, and the produced single cell was operated. The operating temperature for the cell was set to 80° C., and power generation evaluation and AC impedance measurement were performed. The measurement method involved measuring changes in voltage and IR when a current flowing through a load was changed.

### EXAMPLE 2

In this example, a platinum wire-shaped catalyst produced by means of a condensation method from a vapor phase is used to produce a membrane electrode assembly.

First, platinum was vacuum-encapsulated in a reaction tube, and the tube was left standing in a reactor. Then, a temperature of 1,650° C. was applied to a source material site to evaporate platinum, and the temperature at an upper portion inside the reaction tube was set to 750 to 950° C., thereby enabling a platinum wire-shaped catalyst to be produced. The produced platinum wire-shaped catalyst was shed from the reaction tube. The wire-shaped catalyst had a length of 1,000 nm and a diameter of 50 nm. A membrane electrode assembly was produced in the same manner as in Example 1, and furthermore a cell was produced.

As a comparative example, a membrane electrode assembly was produced in the same manner as that described above by means of fine particles having an average particle size of 5 nm, and the member was used to produce a cell.

The single fuel cell was evaluated for current-potential characteristics. As a result, this example showed an improvement of output by about 10% as compared to the fine particle membrane of the comparative example. This is probably because the incorporation of the platinum wire-shaped catalyst in accordance with the present invention into the membrane electrode assembly has enabled the triple phase boundary to be increased and the gas permeability to be increased, thereby leading to an improvement of the power generation efficiency.

### EXAMPLE 3

In this example, a membrane electrode assembly was produced by preparing silica nanoholes on a conductive substrate, making a platinum-tungsten alloy wire-shaped catalyst by means of a plating method, fixing a polymer electrolyte membrane on the template, dissolving the template, and placing the polymer electrolyte membrane on the dendritic wire-shaped catalyst.

0.7 mol of nitric acid, 12 mol of water, 15 mol of ethanol, and 0.2 mol of n-hexadecyltrimethylammoniumchloride with respect to 1 mol of tetraethylorthosilicate (TEOS) were used as source materials for preparing a reaction liquid for making a silica nanohole. The liquid was put on a silicon wafer having a copper film formed thereon, and the whole was subjected to spin coating at 3,000 rpm. After that, the resultant was heat treated in the air at 400° C. to make silica nanoholes.

Next, chloroplatinic acid (1.5 g in terms of platinum concentration) and sodium tungstate (10 g in terms of tungsten concentration) were dissolved into 800 ml of water, and then 1.0 g of disodium hydrogenphosphate and 1.0 g of sodium dihydrogen phosphate were added to the solution. Furthermore, a Pt—W alloy plating bath having a predetermined pH value with the aid of sodium hydroxide and sulfuric acid was prepared. The bath was used to perform plating under the electrolysis conditions of: a current density of 5 mA/cm²; a plating time of 150 seconds; and a plating temperature of 65° C., to prepare two identical substrate samples.

Next, a 5% Nafion solution was applied to the two substrates by means of spin coating. Immediately after that, a Nafion membrane was sandwiched between the spin-coated surfaces of the two substrates, and the resultant was directly subjected to hot pressing.

Next, the resultant (substrate-Nafion membrane-substrate) was immersed in an aqueous solution of sodium hydroxide and then in an aqueous solution of nitric acid to dissolve the template, thereby making a membrane electrode assembly with a dendritic structure reflecting the template and having an average diameter of about 5 nm. After that, a 5% Nafion solution was additionally dropped onto both surfaces of the membrane electrode assembly to increase the triple phase boundary.

As a comparative example, a membrane electrode assembly was produced by means of platinum-tungsten alloy fine particles having an average particle size of 5 nm, and the member was used to produce a cell.

The single fuel cell was evaluated for current-potential characteristics. As a result, this example showed an improvement of output by about 12% as compared to the fine particle membrane of the comparative example. This is probably because the incorporation of the wire-shaped catalyst in accordance with the present invention into the membrane electrode assembly has enabled the triple phase boundary to be increased and the gas permeability to be increased, thereby leading to the improvement of the power generation efficiency.

### EXAMPLE 4

In this example, a membrane electrode assembly was produced by preparing alumina nanoholes on a conductive substrate; making a platinum-cobalt mixture wire-shaped catalyst by means of a pulse plating method; and mixing the wire-shaped catalyst with platinum fine particles.

First, an aluminum electrode to serve as a working electrode and an aluminum electrode to serve as a counter electrode were put in a 0.3M aqueous solution of sulfuric acid held at 3° C. by a constant temperature water tank. Here, an anodic oxidation voltage was DC 25 V, and a current value was displayed on a monitor. The electrodes were observed to be penetrated up to a base layer at the time when the current value reduced.

After the anodic oxidation, washing with pure water and isopropyl alcohol was performed.

After that, a pore widening treatment involving immersion in a 5 wt. % phosphoric acid solution was performed for 20 minutes to make alumina nanoholes having an average pore size of 20 nm.

Next, an aqueous solution composed of 0.003 mol/l of chloroplatinic acid hexahydrate, 0.3 mol/l of cobalt (II) sulfate heptahydrate, and 30 g/l of boric acid was used at 24° C. Electrodeposition was performed by alternately applying potentials of −1.5 V and −0.6 V by means of Ag/AgCl as a reference electrode in the above solution. Thus, a wire-shaped catalyst having platinum and cobalt stacked therein was made. The wire-shaped catalyst had a length of 1,000 nm and a diameter of 20 nm.

The wire-shaped catalyst was used to produce a membrane electrode assembly in the same manner as the method of producing a membrane electrode assembly in Example 1, to thereby assemble a cell in which hydrogen and oxygen were taken as fuels into an anode side and a cathode side, respectively.

As a comparative example, a membrane electrode assembly was produced in the same manner as that described above by means of platinum-cobalt mixed fine particles produced by means of an immersion method involving applying a solution having a metal salt dissolved therein to fine particles and calcinating the resultant, and the member was used to produce a cell. A ratio between platinum fine particles and cobalt fine particles was the same as that obtained as a result of analysis of a wire-shaped catalyst with EDX.

The single fuel cell was evaluated for current-potential characteristics. As a result, this example showed an improvement of output by about 12% as compared to the fine particle membrane of the comparative example. This is probably because the incorporation of the platinum wire-shaped catalyst in accordance with the present invention into the membrane electrode assembly has enabled the triple phase boundary to be increased and the gas permeability to be increased, thereby leading to the improvement of the power generation efficiency.

### INDUSTRIAL APPLICABILITY

The membrane electrode assembly in accordance with the present invention can increase the triple phase boundary, can increase the gas permeability, and has improved the power generation efficiency. Therefore, the member can find use in various energy generating parts for fuel cells ranging from fuel cells for small mobile devices such as a mobile phone, a notebook personal computer, a digital camcorder, and a digital camera to large fuel cells for use in home and for automobiles and the like. In addition, the membrane can be used as, for example, an electrode for electrolysis of water also in a field other than the field of a fuel cell.

This application claims priority from Japanese Patent Application No. 2004-300685 filed Oct. 14, 2004, which is hereby incorporated by reference herein.

1. A membrane electrode assembly for a fuel cell, comprising a polymer electrolyte and a catalyst layer, wherein the catalyst layer comprises a wire-shaped catalyst.

2. The membrane electrode assembly according to claim 1, wherein the wire-shaped catalyst has an aspect ratio of 5 or more.

3. The membrane electrode assembly according to claim 1, wherein the wire-shaped catalyst has a diameter of 50 nm or less.

4. The membrane electrode assembly according to claim 1, wherein the wire-shaped catalyst comprises platinum, an alloy containing platinum, and a mixture containing platinum.

5. A method of producing a membrane electrode assembly for a fuel cell comprising a polymer electrolyte and a catalyst layer comprising a wire-shaped catalyst, the method comprising the step of making a wire-shaped catalyst by means of vapor phase growth or liquid phase growth.

6. The method according to claim 5, wherein the vapor phase growth is condensation, thermal decomposition, laser ablation, or VLS.

7. The method according to claim 5, wherein the liquid phase growth is plating, electroless plating, or reduction.

8. A method of producing a membrane electrode assembly for a fuel cell comprising a polymer electrolyte and a catalyst layer comprising a wire-shaped catalyst, the method comprising the steps of:
preparing a template having a hole substantially linearly penetrated therethrough on an electrode;
filling the hole with a substance that serves as a catalyst by means of plating;
dissolving the template with an acid or alkaline solution to give a catalyst layer comprising a wire-shaped catalyst; and
integrating the catalyst layer with a polymer electrolyte.

9. The method according to claim 8, wherein the template comprises an alumina nanohole, a silicon nanohole, or a silica nanohole.

10. A fuel cell, comprising a membrane electrode assembly for a fuel cell comprising a polymer electrolyte and a catalyst layer comprising a wire-shaped catalyst.
